(19) United States
(12) Patent Application Publication
(10) Pub. No.: US 2026/0304583 A1
(43) Pub. Date: Oct. 1, 2026

(54) MODULAR POWER DISTRIBUTION UNIT FOR X-RAY GENERATION

(71) Applicant: GE Precision Healthcare LLC, Waukesha, WI (US)

(72) Inventors: Antonio Caiafa, Brookfield, WI (US); Yannick Louvrier, BOIS D ARCY (FR)

(21) Appl. No.: 19/094,106

(22) Filed: Mar. 28, 2025

(51) Int. Cl. H05G 1/12; H05G 1/18

(52) U.S. Cl. CPC H05G 1/12; H05G 1/18

(57) ABSTRACT

A PDU includes a motherboard supporting main bus bars, DC bus bars, and AC bus bars, wherein the main bus bars are configured to receive electrical power. The PDU includes one or more mains to DC boards electrically coupling the mains bus bars to the DC bus bars, wherein the one or more mains to DC boards are configured to absorb the electrical power from the mains bus bars, to convert the electrical power to DC power, and to provide the DC power to the DC bus bars. The PDU includes one or more peak-power shaving boards electrically coupling an energy storage system to the DC bus bars, wherein the one or more peak-power shaving boards are configured to access stored DC energy from the energy storage system and to provide the stored DC energy to the DC bus bars when a power demand exceeds a threshold.

### BACKGROUND

The subject matter disclosed herein relates to imaging systems and, more particularly, to a modular power distribution unit for X-ray generation.

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the reflection of acoustic waves, to acquire data and to construct images or otherwise represent the observed internal features of the patient.

For example, in computed tomography (CT) and other X-ray based imaging technologies, X-ray radiation spans a subject of interest, such as a human patient, and a portion of the radiation impacts a detector where the image data is collected. In digital X-ray systems a photodetector produces signals representative of the amount or intensity of radiation impacting discrete pixel regions of a detector surface. The signals may then be processed to generate an image that may be displayed for review. In CT imaging systems, a detector array, including a series of detector elements, produces similar signals through various positions as a gantry is displaced around a patient.

Certain X-ray imaging systems (e.g., CT imaging systems, X-ray imaging system, mammography imaging system, interventional imaging system, fluoroscopy imaging system) utilize a power distribution unit (PDU) in generating X-rays. In particular, the power distribution unit needs to meet the needs for (continuous and peak) power for the respective X-ray imaging system. There are several varieties of power distribution units that may be needed based on a customer's order. Each power distribution unit is designed and manufactured based on the specific order. In addition, each type of X-ray imaging system (as well as different tiers of the same X-ray imaging modality) has its own dedicated power distribution unit. The same X-ray imaging systems shipped to different countries might need power distribution unit modifications. Further, all existing power distribution units for types of X-ray imaging systems in the world exhibit voltage droop issues. Each power distribution unit line exhibits its own unique failure mode. Further, any modification to an X-ray imaging system requires power distribution unit modifications. New X-ray imaging systems may require power network power increases.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a power distribution unit for an X-ray imaging device is provided. The power distribution unit includes a motherboard mechanically supporting a plurality of main bus bars, a plurality of direct current (DC) bus bars, and a plurality of alternating current (AC) bus bars, wherein the plurality of main bus bars is configured to receive electrical power from an electrical grid. The power distribution unit also includes one or more mains to DC boards electrically coupling the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars. The power distribution unit further includes one or more peak-power shaving boards electrically coupling an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold. The power distribution unit includes a modular architecture.

In another embodiment, a medical imaging system is provided. The medical imaging system includes an X-ray source configured to emit X-rays. The medical imaging system also includes a high voltage generator configured to provide power to the X-ray source. The medical imaging system also includes a power distribution unit having a modular architecture and configured to receive electrical power from an electrical grid and to store the electrical power, wherein the power distribution unit is configured to regulate a high voltage (500V to 800V) direct current (DC) outputted to components of the medical imaging system including the high voltage generator. The power distribution unit includes a motherboard mechanically supporting a plurality of main bus bars, a plurality of DC bus bars, and a plurality of alternating current (AC) bus bars, wherein the plurality of main bus bars is configured to receive the electrical power from the electrical grid. The power distribution unit also includes one or more mains to DC boards electrically coupling the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars. The power distribution unit further includes one or more peak-power shaving boards electrically coupling an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold.

In a further embodiment, a method for manufacturing a modular power distribution unit for an X-ray imaging device is provided. The method includes providing a motherboard mechanically supporting a plurality of main bus bars, a plurality of direct current (DC) bus bars, and a plurality of alternating current (AC) bus bars, wherein the plurality of main bus bars is configured to receive electrical power from an electrical grid. The method also includes coupling one or more mains to DC boards to the motherboard to electrically couple the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars. The method further includes coupling one or more peak-power shaving boards to the motherboard to electrically couple an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold or to receive the electrical power to recharge the energy storage system.

### BRIEF DESCRIPTION OF THE DRAWINGS

These and other features, aspects, and advantages of the disclosed subject matter will become better understood when the following detailed description is read with reference to the accompanying drawings in which like characters represent like parts throughout the drawings, wherein:

FIG. 1 is a combined pictorial view and block diagram of a computed tomography (CT) imaging system as discussed herein;

FIG. 2 is a block diagram for a medical imaging load, in accordance with aspects of the present disclosure;

FIG. 3 are schematic diagrams of a modular power distribution unit (e.g., having a common energy storage element), in accordance with aspects of the present disclosure;

FIG. 4 are schematic diagrams of a modular power distribution unit (e.g., having multiple separate energy storage elements), in accordance with aspects of the present disclosure;

FIG. 5 are schematic diagrams of a modular power distribution unit (e.g., having mains to AC boards), in accordance with aspects of the present disclosure;

FIG. 6 are schematic diagrams of a modular power distribution unit (e.g., having multiple separate energy storage elements for both AC and DC power), in accordance with aspects of the present disclosure;

FIG. 7 is a schematic diagram of a modular power distribution unit for a CT imaging system requiring 200 kilo-volt-amperes (kVA) (e.g., having an energy storage system), in accordance with aspects of the present disclosure;

FIG. 8 is a schematic diagram of a modular power distribution units for a CT imaging system requiring 200 (kVA) (e.g., lacking an energy storage system), in accordance with aspects of the present disclosure;

FIG. 9 is a schematic diagram of a DC uninterruptible power supply coupled to the modular power distribution unit in FIG. 7, in accordance with aspects of the present disclosure;

FIG. 10 is a schematic diagram of an AC uninterruptible power supply coupled to the modular power distribution unit in FIG. 7, in accordance with aspects of the present disclosure;

FIG. 11 is a schematic diagram of a modular power distribution unit for a CT imaging system requiring 210 kVA and 3 kVA for reconstruction (e.g., having an energy storage system), in accordance with aspects of the present disclosure;

FIG. 12 is a schematic diagram of a modular power distribution unit for a CT imaging system requiring 210 kVA and 13 kVA for reconstruction (e.g., not having an energy storage system), in accordance with aspects of the present disclosure; and

FIG. 13 is a flowchart of a method for manufacturing a modular power distribution unit for an X-ray imaging device, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where an X-ray source is utilized.

The present disclosure provides embodiments for a modular power distribution unit for a medical imaging system. The medical imaging system may be an X-ray source configured to emit X-rays. For example, the medical imaging system may be a computed tomography imaging system, a fluoroscopy imaging system, an interventional imaging system, and a radiography imaging system (i.e., conventional imaging system including a mammography imaging system). In certain embodiments, the medical imaging system may be utilized with a magnetic resonance imaging system. Although discussed in the context of medical imaging, the modular power distribution unit may be utilized with electric vehicles, energy storage, battery chargers, and other applications.

The modular power distribution unit provides a plug and play power distribution unit (e.g., common power distribution unit) for powering all types of X-ray systems. The modular power distribution unit is configured for all loads. The modular power distribution unit has a modular architecture built from four different types of boards. The different types of boards provide building blocks for every product. In certain embodiments, the four types of boards include a motherboard, a mains to DC board, a DC to AC board, and a peak-power shaving board. In certain embodiments, the four types of boards include a motherboard, a mains to DC board, a mains to AC board, and a peak-power shaving board. The different types of boards (in particular, the mains to DC board and the DC to AC board) are programmable to regulate voltages and frequencies. The programmability allows the same hardware to fit any hardware needs as well as most of the power network parameters (i.e. nominal voltage and frequency). The modular power distribution unit is configured to be coupled to a DC uninterruptible power supply (UPS) or an AC uninterruptible power supply to support basic operation over a longer period of power outage.

The modular power distribution unit can be easily and inexpensively scaled to product needs. The modular power distribution unit provides redundancies for maintenance and repair with no downtime. In particular, a single fault will not take down all of the power distribution unit. The modular power distribution unit can integrate peak-power shaving and energy storage. A power network upgrade may not be required with the availability (integration) of peak-power shaving. The modular power distribution unit includes a regulated (self-regulated) DC bus. This self-regulation avoids voltage droop issues when the unit is loaded. The modular power distribution unit can also include a built-in hot-landing feature.

The design and manufacture of limited number of boards for the modular power distribution unit allows for scaling through different products as well as different modalities and options. The modular power distribution unit includes fully programmable output voltages (both AC and DC), thus, providing the same hardware for different applications and/or power network connections. The modular power distribution unit reduces cost due to mass production of a limited number of different boards. The modular power distribution unit provides the option to add redundancies. The modular power distribution unit can be tailored to a customer's needs and/or to provide a solution for power availability. The modular power distribution unit provides a more compact design than typical power distribution units. The modular power distribution unit may also include smart power monitoring and control options. The modular power distribution unit enables the upgrading of a system in the future by simply upgrading their existing modular power distribution unit.

The disclosed embodiments include a power distribution unit for an X-ray imaging device. The power distribution unit includes a motherboard mechanically supporting a plurality of main bus bars, a plurality of direct current (DC) bus bars, and a plurality of alternating current (AC) bus bars, wherein the plurality of main bus bars is configured to receive electrical power from an electrical grid. The power distribution unit also includes one or more mains to DC boards electrically coupling the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars. The power distribution unit further includes one or more peak-power shaving boards electrically coupling an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold. The energy storage system is also configured to receive the electrical power to recharge the energy storage system. The power distribution unit includes a modular architecture.

In certain embodiments, the modular architecture of the power distribution unit is configured for use with different types of a same X-ray imaging modality and with different types of X-ray imaging modalities. In certain embodiments, the one or more mains to DC boards are configured to regulate DC voltage of the DC power provided to the plurality of DC bus bars to a set DC voltage value.

In certain embodiments, the power distribution unit includes one or more DC to AC boards electrically coupling the plurality of DC bus bars to the plurality of AC bus bars, wherein the one or more DC to AC boards are configured to absorb the DC power from the plurality of DC bus bars, to convert the DC power to AC power, and to provide the AC power to the plurality of AC bus bars. In certain embodiments, the one or more DC to AC boards are configured to regulate AC voltage of the AC power provided to the plurality of AC bus bars to both a set amplitude and a set frequency. In certain embodiments, the one or more DC to AC boards are configured to provide single phase AC power to the plurality of AC bus bars. In certain embodiments, the one or more DC to AC boards are configured to provide three-phase AC power to the plurality of AC bus bars. The configuration can be implemented by selecting proper firmware and/or by hardware modification.

In certain embodiments, the one or more peak-power shaving boards are configured to provide some of the DC power to the energy storage system for storage. In certain embodiments, the one or more peak-power shaving boards include a plurality of the peak-power shaving boards, and the energy storage system includes a common energy storage element coupled to each peak-power shaving board of the plurality of peak-power shaving boards. In certain embodiments, the one or more peak-power shaving boards include a plurality of the peak-power shaving boards, and the energy storage system includes a plurality of energy storage elements, and each energy storage element of the plurality of energy storage elements is separately coupled to a respective peak-power shaving board of the plurality of peak-power shaving boards.

In certain embodiments, the power distribution unit further includes one or more mains to AC boards electrically coupling the plurality of mains bus bars to the plurality of AC bus bars, wherein the one or more mains to DC boards are configured to absorb the electrical power from the plurality of mains bus bars and to provide AC power to the plurality of AC bus bars. In certain embodiments, the power distribution unit includes one or more additional peak-power shaving boards electrically coupling an additional energy storage system to the plurality of AC bus bars, wherein the one or more additional peak-power shaving boards are configured to access stored DC energy from the additional energy storage system and to provide the stored DC energy to the plurality of AC bus bars when a power demand exceeds a programmed threshold. The additional energy storage system is also configured to receive the electrical power to recharge the additional energy storage system. In certain embodiments, the one or more additional peak-power shaving boards include a plurality of the additional peak-power shaving boards, and the additional energy storage system includes a common energy storage element coupled to each additional peak-power shaving board of the plurality of additional peak-power shaving boards. In certain embodiments, the one or more additional peak-power shaving boards include a plurality of the additional peak-power shaving boards, and the additional energy storage system includes a plurality of energy storage elements, and each energy storage element of the plurality of energy storage elements is separately coupled to a respective additional peak-power shaving board of the plurality of additional peak-power shaving boards.

In certain embodiments, the plurality of DC bus bars is configured to couple to a DC uninterruptible power supply. In certain embodiments, the plurality of AC bus bars is configured to couple to an AC uninterruptible power supply.

The disclosed embodiments include a method for manufacturing a modular power distribution unit for an X-ray imaging device. The method includes providing a motherboard mechanically supporting a plurality of main bus bars, a plurality of direct current (DC) bus bars, and a plurality of alternating current (AC) bus bars, wherein the plurality of main bus bars is configured to receive electrical power from an electrical grid. The method also includes coupling one or more mains to DC boards to the motherboard to electrically couple the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars. The method further includes coupling one or more peak-power shaving boards to the motherboard to electrically couple an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold or to receive the electrical power to recharge the energy storage system. In certain embodiments, the modular power distribution unit does not include peak-power shaving. In certain embodiments, the method includes coupling one or more DC to AC boards to the motherboard to electrically couple the plurality of DC bus bars to the plurality of AC bus bars, wherein the one or more DC to AC boards are configured to absorb the DC power from the plurality of DC bus bars, to convert the DC power to AC power, and to provide the AC power to the plurality of AC bus bars.

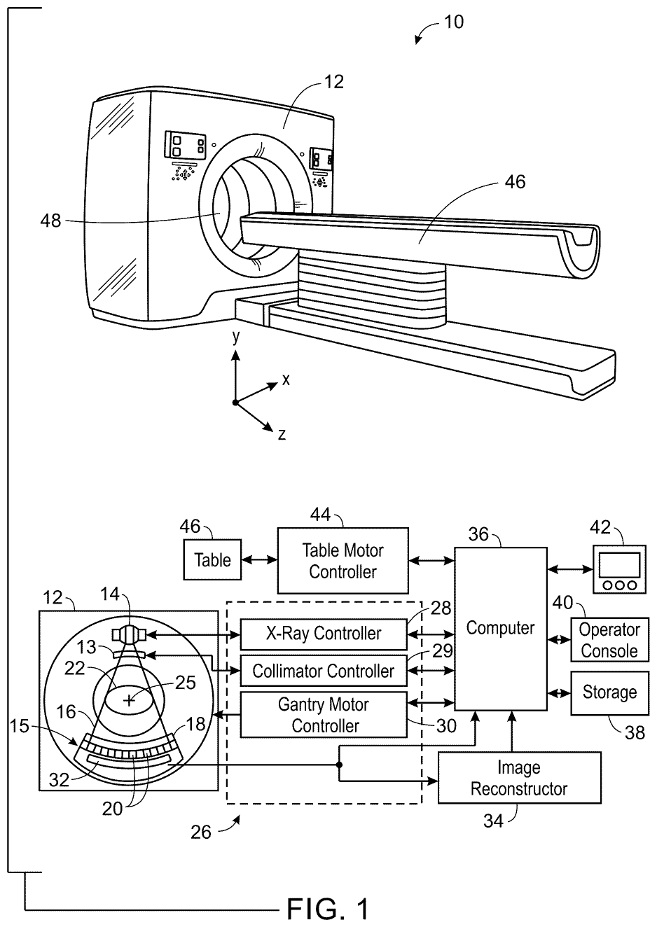

With the preceding in mind and referring to FIG. 1, a computed tomography (CT) imaging system 10 is shown, by way of example. The CT imaging system 10 includes a gantry 12. The gantry 12 has an X-ray source 14 that projects a beam of X-rays 16 toward a detector assembly 15 on the opposite side of the gantry 12. The X-ray source 14 projects the beam of X-rays 16 through a pre-patient collimator assembly 13 that determines the size and shape of the beam of X-rays 16. The detector assembly 15 includes a collimator assembly 18 (a post-patient collimator assembly), a plurality of detector modules 20 (e.g., detector elements or sensors), and data acquisition systems (DAS) 32. The plurality of detector modules 20 detect the projected X-rays that pass through a subject or object 22 being imaged, and DAS 32 converts the data into digital signals for subsequent processing. Each detector module 20 in a conventional system produces an analog electrical signal that represents the intensity of an incident X-ray beam and hence the attenuated beam as it passes through the subject or object 22. During a scan to acquire X-ray projection data, gantry 12 and the components mounted thereon rotate about a center of rotation 25 (e.g., isocenter) so as to collect attenuation data from a plurality of view angles relative to the imaged volume.

Rotation of gantry 12 and the operation of X-ray source 14 are governed by a control system 26 of CT imaging system 10. Control system 26 includes an X-ray controller 28 that provides power and timing signals to an X-ray source 14, a collimator controller 29 that controls a length and a width of an aperture of the pre-patient collimator 13 (and, thus, the size and shape of the beam of X-rays 16), and a gantry motor controller 30 that controls the rotational speed and position of gantry 12. An image reconstructor 34 receives sampled and digitized X-ray data from DAS 32 and performs high-speed image reconstruction. The reconstructed image is applied as an input to a computer 36, which stores the image in a storage device 38. Computer 36 also receives commands and scanning parameters from an operator via console 40. An associated display 42 allows the operator to observe the reconstructed image and other data from computer 36. The operator supplied commands and parameters are used by computer 36 to provide control signals and information to DAS 32, X-ray controller 28, collimator controller 29, and gantry motor controller 30. In addition, computer 36 operates a table motor controller 44, which controls a motorized table 46 (e.g., patient table) to position subject 22 and gantry 12. Particularly, table 46 moves portions of subject 22 through a gantry opening or bore 48.

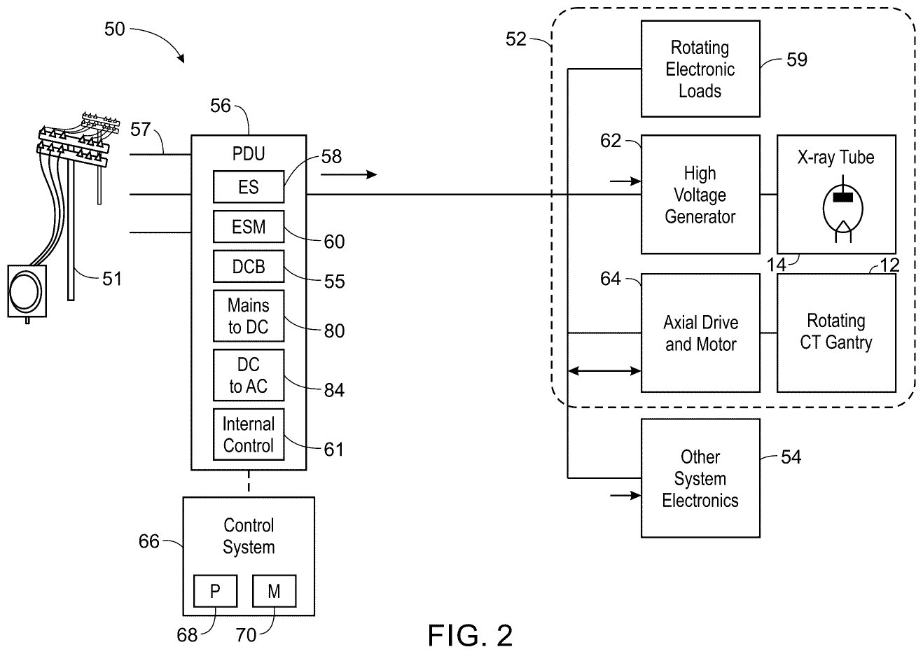

FIG. 2 is discussed in the context of a computed tomography imaging system. As noted above, the disclosed embodiments can be utilized with other medical imaging systems having an X-ray source (e.g., a fluoroscopy imaging system and a radiography imaging system). FIG. 2 is a power supply system 50 that provides power to one or more medical imaging loads 52 (e.g., computed tomography imaging system 10 of FIG. 1) and/or other electronics 54 (e.g., computer 36, console 40, and/or display 42 for computed tomography imaging system 10). A main alternating current (AC) power source (e.g., from an electrical grid) may provide power (e.g., single phase or polyphase AC power such as 3-phase AC power) via an AC power line 51 to a power distribution unit (PDU) 56 via an AC input 57 (e.g., single phase or 3-phase power plug). The power distribution unit 56 may convert the AC power to DC power and provide the DC power to the medical imaging loads 52 and/or other electronics 54. In certain embodiments, the power distribution unit 56 also provides AC power to the medical imaging loads 52 and/or other electronics 54. In certain embodiments, the power distribution unit 56 also provides power to rotating electronic loads 59. As described in greater detail below, the power distribution unit 56 includes mains to DC boards 80 and DC to AC boards 84.

In certain embodiments, the power distribution unit 56 includes an active rectifier. The power distribution unit 56 is disposed outside a stationary portion of the CT imaging scanner of the system 10. Power may be transmitted from the stationary portion to a rotating portion of the CT imaging scanner of the system 10 via a slip ring or wirelessly. In certain embodiments, power distribution unit 56 includes a digital control board (DCB) 55 for online power monitoring. The digital control board 55 is also configured for performing diagnostics offline or remotely if there is any issue on the power distribution unit 56 or with the active rectifier. The digital control board 55 controls operation of the active rectifier. In certain embodiments, the active rectifier is communicatively coupled to a controller (e.g., controller for gantry) on the system 10 to enable the controller both to monitor and to diagnose any issues with the power distribution unit 56. In certain embodiments, the active rectifier is communicatively coupled to the controller via an Ethernet connection (or other type of communication interface such as serial or controller area network). The system 10 may monitor and/or report on different parameters of the power supply system 50 (e.g., power distribution unit 56 including the active rectifier). These parameters may include input voltage, input current, battery voltage charge current, inverter AC voltage, inverter AC current, heat sink temperature, all board rail voltages, and other parameters. These parameters may be communicated (e.g., wired or wirelessly) from the controller to the host computer 36 and/or console 40. Besides monitoring, diagnostics may be performed on the power distribution unit 56 by the controller (via the communication interface).

The power distribution unit 56 includes an energy storage system 58 configured to store electrical power provided by the AC power line 51. In certain embodiments, the energy storage system 58 includes one or more energy storage components. For example, in certain embodiments, the energy storage system 58 may include a battery system having one or more battery banks. In certain embodiments, the energy storage components may include a plurality of batteries stacked in series, super capacitors, or other storage elements. In certain embodiments, the energy storage system 58 is utilized as an uninterruptible power supply (UPS). For example, the UPS may be utilized to provide power (e.g., backup power) during operation of the CT system 10 (e.g., peak power operation). In certain embodiments, the power distribution unit 56 does not include an energy storage system.

The power distribution unit 56 also includes an energy storage management system 60 configured to manage or control the storage on and distribution of power from the energy storage system 58. In certain embodiments, the energy storage management system 60 may include a battery charger and control circuitry. In certain embodiments, the energy storage management system 60 is configured to enable storage of the electrical power on the energy storage system 58 (e.g., batteries) without pre-regulation of the electrical power. In certain embodiments, the energy storage management system 60 is configured to perform peak-power shaving utilizing the energy storage system 58 (e.g., during an imaging scan) by turning off power provided to the battery charger during acceleration of the gantry 12 and subsequently turning on power to the battery charger during emissions of X-rays from the X-ray source 14 (e.g., X-ray tube). In certain embodiments, the energy storage management system 60 is configured to monitor a life of the batteries of the energy storage system 58 and to provide an indication that the batteries are nearing an end of the life via a user interface. For example, the energy storage management system 60 may monitor the equivalent series resistance (ESR) of the batteries and compared it to a threshold (e.g., maximum allowable ESR value). In certain embodiments, the energy storage management system 60 may determine a charge status of the batteries and/or determine whether an imaging scan can be conducted. For example, the energy storage management system 60 may utilize the batteries for the peak power operation when there is enough charge in the batteries or, if there is not enough charge, wait to utilize the batteries for peak power operation when there is enough charge.

While one or more medical imaging loads 52 are described below with respect to loads for a computed tomography (CT) system, it will be appreciated that embodiments are applicable for use with other imaging configurations. The one or more medical imaging loads 52 may include a high voltage generator 62 coupled to the power distribution unit 56 and/or rotating electronic loads 59 coupled to the power distribution unit 52. The high voltage generator 62 may provide power to an X-ray tube 14, of the computed tomography (CT) imaging system 10. The X-ray tube 14 may emit X-ray beams toward a subject or object, such as a patient. The beam, after being attenuated by the subject, impinges upon an array of radiation detector. The intensity of the attenuated beam radiation received at the detector array may be dependent upon the attenuation of the X-ray beam by the subject. Each detector element of the detector array produces a separate electrical signal indicative of the attenuated beam received by each detector element. The electrical signals are transmitted to a data processing system for analysis which produces an image. Further, the X-ray source and the detector array may be rotated, via an axial drive and motor 64, about the gantry 12 within an imaging plane and around the subject or object. When the gantry 12 is rotated, it converts the power from the power distribution unit 56 to rotational kinetic energy via the motor 64.

There are two types of controls: internal (internal control 61) and external (e.g., in the form of control system 66). The internal control 61 controls the various switches to produce the commanded voltage/current/power when needed. The external control tells the power distribution unit 56 which voltage/current/power is needed and when. The internal control 61 can be centralized, distributed, or hybrid. The internal control 61 when centralized consists of a control hardware (DSP/FPGA/CPUs or a combination) located directly on the mother board that sends commands to all the switches. The internal control 61 when it is a distributed control is control hardware that is located on each board (more of them but simpler). The internal control 61 when it is hybrid control, is located on both mother board as well as each one of the other boards. The external control can be located outside the power distribution unit 56 and can be located with the gantry control system. The power distribution unit 56 may be controlled (via control signals) by a control system 66 having a FPGA or processor 68 or multiple FPGA or multiple processors and memory 70. In certain embodiments, the control system 66 is part of the power distribution unit 56 (e.g., energy storage management system 60). In certain embodiments, the control system 66 is a stand-alone unit. The processor 68 may be operatively coupled to the memory 70 to execute instructions for carrying out the presently disclosed techniques. These instructions may be encoded in programs or code stored in a tangible non-transitory computer-readable medium, such as the memory 70 and/or other storage. The processor 68 may be a general purpose processor (e.g., processor of a desktop/laptop computer), system-on-chip (SoC) device, or application-specific integrated circuit, or some other processor configuration. The memory 70, in the embodiment, includes a computer readable medium, such as, without limitation, a hard disk drive, a solid state drive, diskette, flash drive, a compact disc, a digital video disc, random access memory (RAM), and/or any suitable storage device that enables the processor 68 to store, retrieve, and/or execute instructions and/or data. The memory 70 may include one or more local and/or remote storage devices. The processor 68 may control components of the power distribution unit 56 (e.g., charger, batteries, etc.) to provide power to the one or more medical imaging loads 52.

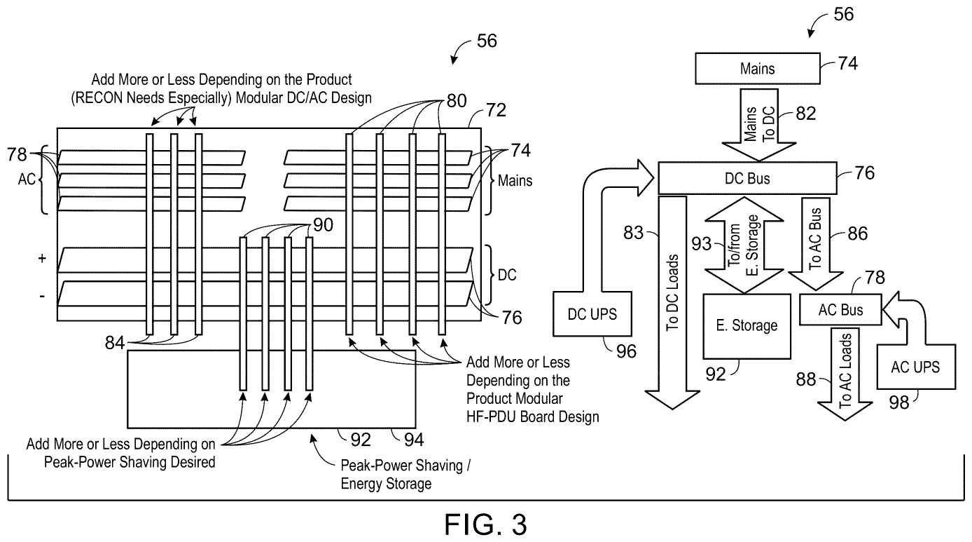

FIG. 3 are schematic diagrams of the modular power distribution unit 56. The left side of FIG. 3 is a schematic diagram of the physical structure of the modular power distribution unit 56. The right side of FIG. 3 is a schematic diagram of a hybrid functional/physical structure of the modular power distribution unit 56. The modular power distribution unit 56 is configured for regulating power and providing peak-power shaving to the X-ray imaging system (e.g., CT imaging system). Each component of the modular power distribution unit 56 is not shown. The modular power distribution unit 56 is a plug and play power distribution unit that has a modular architecture. The modular architecture is configured for use with different types of a same X-ray imaging modality and with different types of X-ray imaging modalities.

The modular power distribution unit 56 is made up of different types of boards. The modular power distribution unit 56 includes a motherboard 72 (e.g., main printed circuit board). The motherboard 72 includes contactors and connections to the mains (e.g., electrical power from electrical grid) and one or more gantries of one or more X-ray imaging systems. In certain embodiments, the modular power distribution unit 56 includes a smart power monitoring option (e.g., DCB 55 in FIG. 2) as part of the motherboard 72 that can be leveraged from an active rectifier. In certain embodiments, the modular power distribution unit 56 includes a control board as part of the motherboard 72. The mains to DC boards 80, the peak-power shaving boards 90, and the DC to AC boards 84 are orientated crosswise to a plane of the motherboard 72 (i.e., extend out from the page). In certain embodiments, the orientation of the components and/or the mounting strategy may differ from that described.

The motherboard 72 mechanically supports various buses (e.g. copper bars) and the different types of boards coupled to the motherboard 72. A main AC power source (e.g., from an electrical grid) may provide power (e.g., single phase or polyphase AC power such as 3-phase AC power) via an AC power line to the modular power distribution unit 56 via an AC input (e.g., single phase or 3-phase power plug). As depicted, the motherboard 72 mechanically supports a plurality of mains bus bars 74 that are configured to receive the electrical power from the electrical grid. The motherboard 72 also mechanically supports a plurality of DC bus bars 76 (e.g., +and − (as depicted), and, if necessary, neutral (not shown)). The motherboard 72 further mechanically supports a plurality of AC bus bars 78. The number of mains bus bars 74 and the number of AC bus bars 78 may vary depending on the type of AC power received and outputted. As depicted, the number of mains bus bars 74 and the number of AC bus bars 78 are for 3-phase AC power.

The modular power distribution unit 56 includes one or more mains to DC boards 80 coupled to the motherboard 72. The number of mains to DC boards 80 may vary (e.g., 1, 2, 3, 4, or more boards 80) depending on the need. As depicted, the modular power distribution unit 56 includes four mains to DC boards 80. The one or more mains to DC boards 80 electrically couple the plurality of mains bus bars 74 to the plurality of DC bus bars 76. In particular, the one or more mains to DC boards 80 are configured to absorb the electrical power (AC power) from the plurality of mains bus bars 74, to convert the electrical power to DC power, and to provide the DC power to the plurality of DC bus bars 76 as indicated by arrow 82. The one or more mains to DC boards 80 are configured to regulate (e.g., via self-regulation) DC voltage of the DC power provided to the plurality of DC bus bars 76 to a set DC voltage value (which can be different from application to application). Each mains to DC board 80 may include control switches, a controller, and AC to DC converter (e.g., internal control 61 in FIG. 2). The plurality of DC bus bars 76 may provide DC power to DC loads of the X-ray medical imaging system as indicated by arrow 83.

In certain embodiments, as depicted in FIG. 3, the modular power distribution unit 56 also includes one or more DC to AC boards 84. The number of DC to AC boards 84 may vary (e.g., 1, 2, 3, 4, or more boards 84) depending on the need. As depicted, the modular power distribution unit 56 includes three DC to AC boards 84. The one or more DC to AC boards 84 electrically couple the plurality of DC bus bars 76 to the plurality of AC bus bars 78. The one or more DC to AC boards 84 are configured to absorb the DC power from the plurality of DC bus bars 76, to convert the DC power to AC power, and to provide the AC power to the plurality of AC bus bars 78 as indicated by arrow 86. The one or more DC to AC boards 84 are configured to regulate AC voltage of the AC power provided to the plurality of AC bus bars 78 to both a set amplitude and a set frequency (which can be different from application to application). Each DC to AC board 84 may include control switches, a controller, and AC to DC inverter. The plurality of AC bus bars 78 may provide power to AC loads of the X-ray medical imaging system as indicated by arrow 88.

The modular power distribution unit 56 includes one or more peak-power shaving boards 90. The number of peak-power shaving boards 90 may vary (e.g., 1, 2, 3, 4 or more boards 90). Certain embodiments might not require any peak-power shaving boards. As depicted, the modular power distribution unit 56 includes four peak-power shaving boards 90. The one or more peak-power shaving boards 90 electrically couple an energy storage system 92 (e.g., energy storage system 58 in FIG. 2) to the plurality of DC bus bars 76. The energy storage system 92 may include batteries (lithium or lead batteries) or supercapacitors (e.g., electrochemical capacitors), or other storage elements. The one or more peak-power shaving boards 90 are configured to access stored DC energy from the energy storage system 92 and to provide the stored DC energy to the plurality of DC bus bars 76 when a power demand exceeds a programmed threshold (e.g., during peak-power shaving) as indicated by arrow 93. The one or more peak-power shaving boards 90 are also configured to provide some of the DC power to the energy storage system 92 for storage as indicated by arrow 93. As depicted, the energy storage system 92 (e.g., energy storage board) includes a common energy storage element 94 (e.g., single energy storage element) coupled to each peak-power shaving board 90.

In certain embodiments, the plurality of DC bus bars 76 is configured to couple to a DC uninterruptible power supply 96 (e.g., having batteries, supercapacitors, etc.). In certain embodiments, the plurality of AC bus bars 78 is configured to couple to an AC uninterruptible power supply 98 (e.g., having batteries, supercapacitors, etc.).

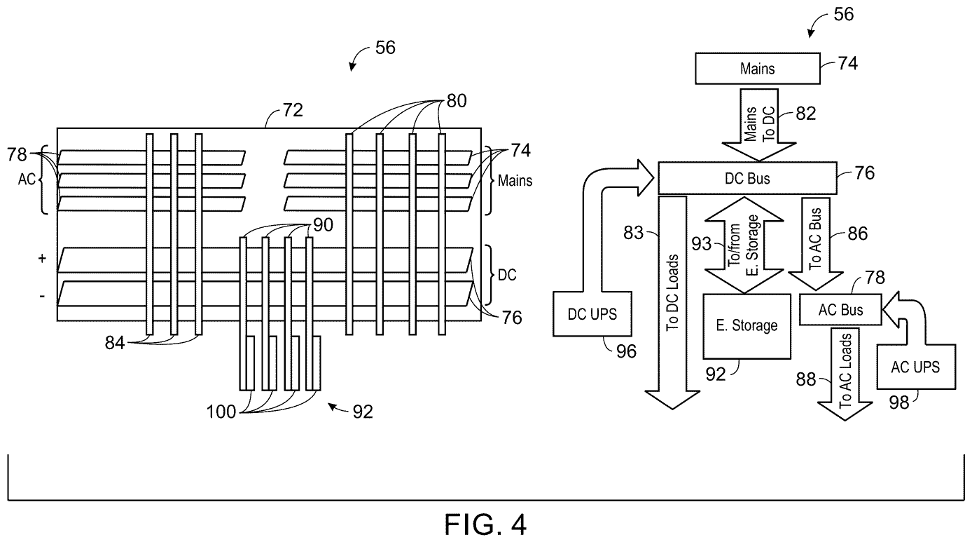

FIG. 4 are schematic diagrams of the modular power distribution unit 56. The modular power distribution unit 56 in FIG. 4 is similar to the modular power distribution unit 56 in FIG. 3 except with respect to the energy storage system 92. The energy storage system 92 in FIG. 4 includes a plurality of energy storage elements 100. Each energy storage element 100 of the plurality of energy storage elements 100 is separately coupled to a respective peak-power shaving board 90 of the plurality of peak-power shaving boards 90. Thus, each peak-power shaving board 90 has its own energy storage element 100. Thus, the energy storage is distributed.

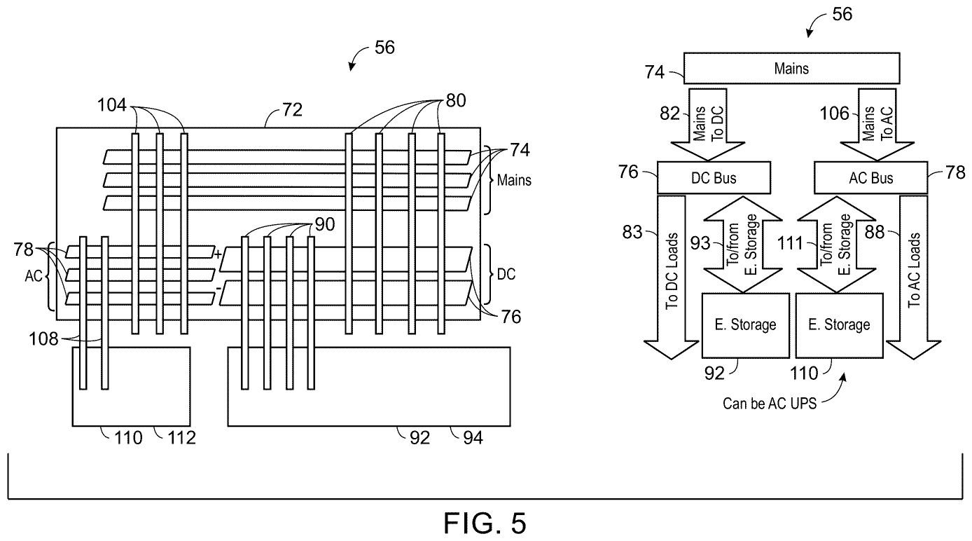

FIG. 5 are schematic diagrams of the modular power distribution unit 56. The left side of FIG. 5 is a schematic diagram of the physical structure of the modular power distribution unit 56. The right side of FIG. 3 is a schematic diagram of a hybrid functional/physical structure of the modular power distribution unit 56. The motherboard 72 is as described in FIG. 3. However, the modular power distribution unit 56 has the AC output power independent from the DC side.

The modular power distribution unit 56 includes one or more mains to DC boards 80 coupled to the motherboard 72. The number of mains to DC boards 80 may vary (e.g., 1, 2, 3, 4, or more boards 80) depending on the need. As depicted, the modular power distribution unit 56 includes four mains to DC boards 80. The one or more mains to DC boards 80 electrically couple the plurality of mains bus bars 74 to the plurality of DC bus bars 76. In particular, the one or more mains to DC boards 80 are configured to absorb the electrical power (AC power) from the plurality of mains bus bars 74, to convert the electrical power to DC power, and to provide the DC power to the plurality of DC bus bars 76 as indicated by arrow 82. The one or more mains to DC boards 80 are configured to regulate (e.g., via self-regulation) DC voltage of the DC power provided to the plurality of DC bus bars 76 to a set DC voltage value (which can be different from application to application). Each mains to DC board 80 may include control switches, a controller (e.g., internal control 61 in FIG. 2 in a local or hybrid form), and AC to DC converter. The plurality of DC bus bars 76 may provide DC power to DC loads of the X-ray medical imaging system as indicated by arrow 83.

The modular power distribution unit 56 includes one or more peak-power shaving boards 90. The number of peak-power shaving boards 90 may vary (e.g., 1, 2, 3, 4 or more boards 90). In certain embodiments, the modular power distribution unit may not include peak-power shaving boards. As depicted, the modular power distribution unit 56 includes four peak-power shaving boards 90. The one or more peak-power shaving boards 90 electrically couple an energy storage system 92 (e.g., energy storage system 58 in FIG. 2) to the plurality of DC bus bars 76. The energy storage system 92 may include batteries (lithium or lead batteries) or supercapacitors (e.g., electrochemical capacitors), or other storage elements. The one or more peak-power shaving boards 90 are configured to access stored DC energy from the energy storage system 92 and to provide the stored DC energy to the plurality of DC bus bars 76 when a power demand exceeds a programmed threshold (e.g., during peak-power shaving) as indicated by arrow 93. The one or more peak-power shaving boards 90 are also configured to provide some of the DC power to the energy storage system 92 for storage as indicated by arrow 93. As depicted, the energy storage system 92 (e.g., energy storage board) includes a common energy storage element 94 (e.g., single energy storage element) coupled to each peak-power shaving board 90. In certain embodiment, the energy storage system 92 may include multiple energy storage elements.

The modular power distribution unit 56 also includes one or more mains to AC boards 104. The number of mains to AC boards 104 may vary (e.g., 1, 2, 3, 4, or more boards 104) depending on the need. As depicted, the modular power distribution unit 56 includes three mains to AC boards 104. The mains to AC boards 104 electrically couple the plurality of mains bus bars 74 to the plurality of AC bus bars 78. The one or more mains to AC boards 104 are configured to absorb the electrical power from the plurality of mains bus bars 74 and to provide the AC power to the plurality of AC bus bars 78 as indicated by arrow 106. The number of mains bus bars 74 and the number of AC bus bars 78 may vary depending on the type of AC power received and outputted. As depicted, the number of mains bus bars 74 and the number of AC bus bars 78 are for 3-phase AC power. The plurality of AC bus bars 78 may provide power to AC loads of the X-ray medical imaging system as indicated by arrow 88.

The modular power distribution unit 56 includes one or more additional peak-power shaving boards 108. The number of additional peak-power shaving boards 108 may vary (e.g., 1, 2, 3, 4 or more boards 108). As depicted, the modular power distribution unit 56 includes two additional peak-power shaving boards 108. The one or more additional peak-power shaving boards 108 electrically couple an additional energy storage system 110 (e.g., energy storage system 58 in FIG. 2) to the plurality of AC bus bars 78. The additional energy storage system 110 may include batteries (lithium or lead batteries) or supercapacitors (e.g., electrochemical capacitors), or other storage elements. The one or more additional peak-power shaving boards 108 are configured to access stored DC energy from the additional energy storage system 110 and to provide the stored DC energy to the plurality of AC bus bars 78 when a power demand exceeds a programmed threshold (e.g., during peak-power shaving) as indicated by arrow 111. The one or more additional peak-power shaving boards 108 are also configured to provide some of the AC power to the additional energy storage system 110 for storage as indicated by arrow 111. As depicted, the additional energy storage system 110 (e.g., additional energy storage board) includes an additional common energy storage element 112 (e.g., single energy storage element) coupled to each additional peak-power shaving board 108. In certain embodiments, the additional energy storage system 110 may be utilized as AC uninterruptible power supply.

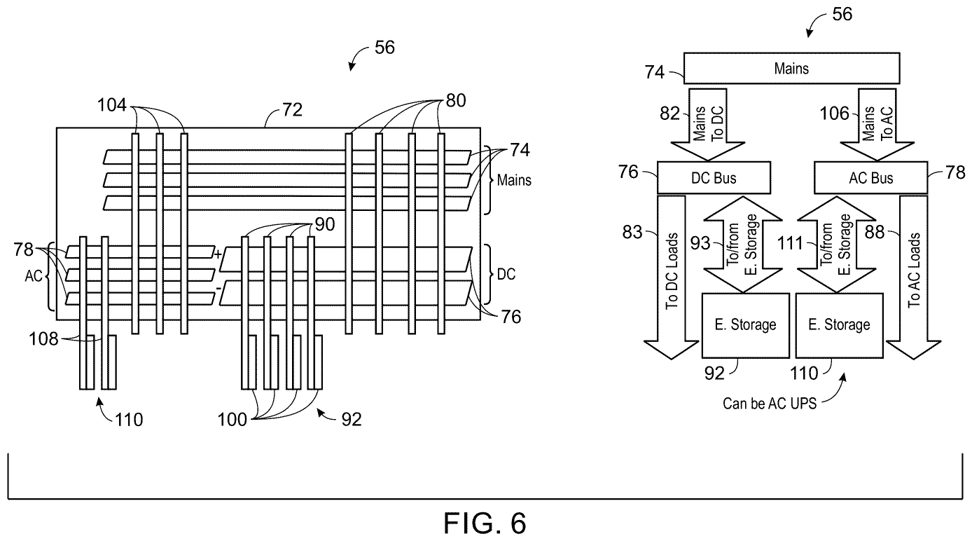

FIG. 6 are schematic diagrams of the modular power distribution unit 56. The modular power distribution unit 56 in FIG. 6 is similar to the modular power distribution unit 56 in FIG. 5 except with respect to the energy storage system 92 and the additional energy storage system 110. The energy storage system 92 in FIG. 6 includes a plurality of energy storage elements 100. Each energy storage element 100 of the plurality of energy storage elements 100 is separately coupled to a respective peak-power shaving board 90 of the plurality of peak-power shaving boards 90. Thus, each peak-power shaving board 90 has its own energy storage element 100. Thus, the energy storage is distributed. The additional energy storage system 110 in FIG. 6 includes a plurality of additional energy storage elements 114. Each additional energy storage element 114 of the plurality of additional energy storage elements 114 is separately coupled to a respective additional peak-power shaving board 108 of the plurality of additional peak-power shaving boards 108. Thus, each additional peak-power shaving board 108 has its own additional energy storage element 114. Thus, the energy storage is distributed. In certain embodiments, the additional energy storage system 110 may be utilized as AC uninterruptible power supply.

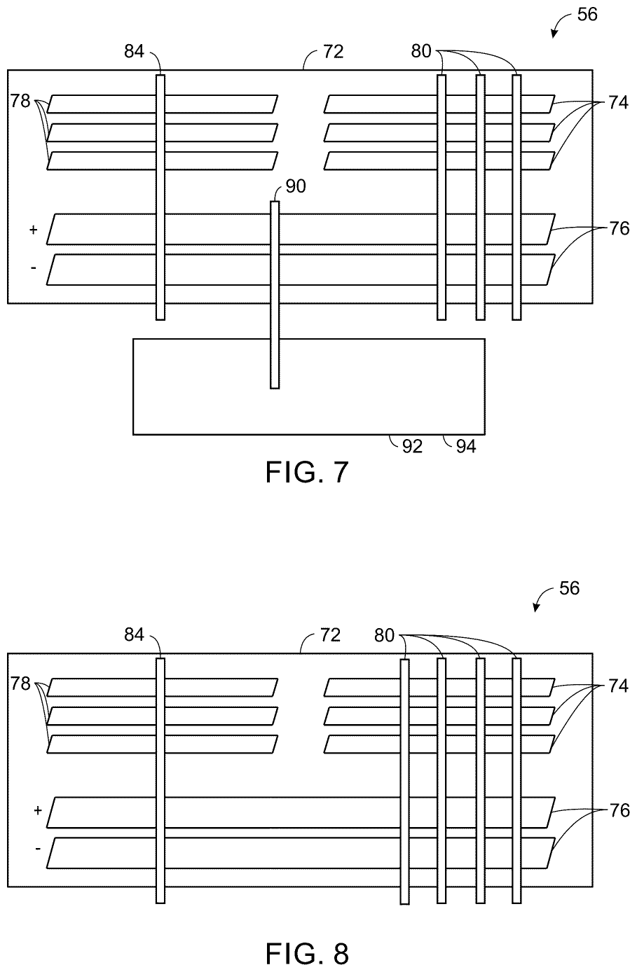

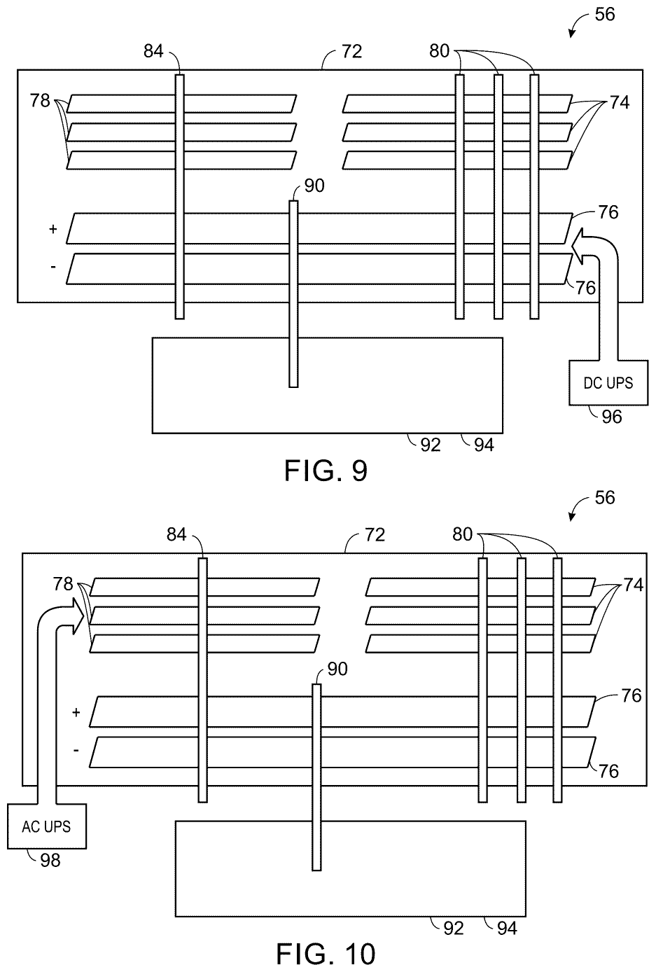

As mentioned above, the modular architecture of the power distribution unit 56 is configured for use with different types of a same X-ray imaging modality and with different types of X-ray imaging modalities. FIGS. 7 and 8 are schematic diagrams of different modular power distribution units 56 for the same CT imaging system requiring 200 kVA. In FIGS. 7 and 8, the mains to DC boards 80 are each rated for 50 kVA and the peak-power shaving boards 90 are each rated for 50 kVA. The modular power distribution unit 56 in FIG. 7 is similar to the power distribution unit 56 in FIG. 3. As depicted in FIG. 7, the modular power distribution unit 56 has three mains to DC boards 80 for a total rating of 150 kVA and one peak-power shaving board 90 for an additional 50 kVA. In contrast, the modular power distribution unit 56 in FIG. 8 lacks an energy storage system and instead has four mains to DC boards 80 for a total rating of 200 kVA. FIG. 9 depicts a DC uninterruptible power supply 96 coupled to the DC bus bars 76. FIG. 10 depicts an AC uninterruptible power supply 98 coupled to the mains bus bars 74.

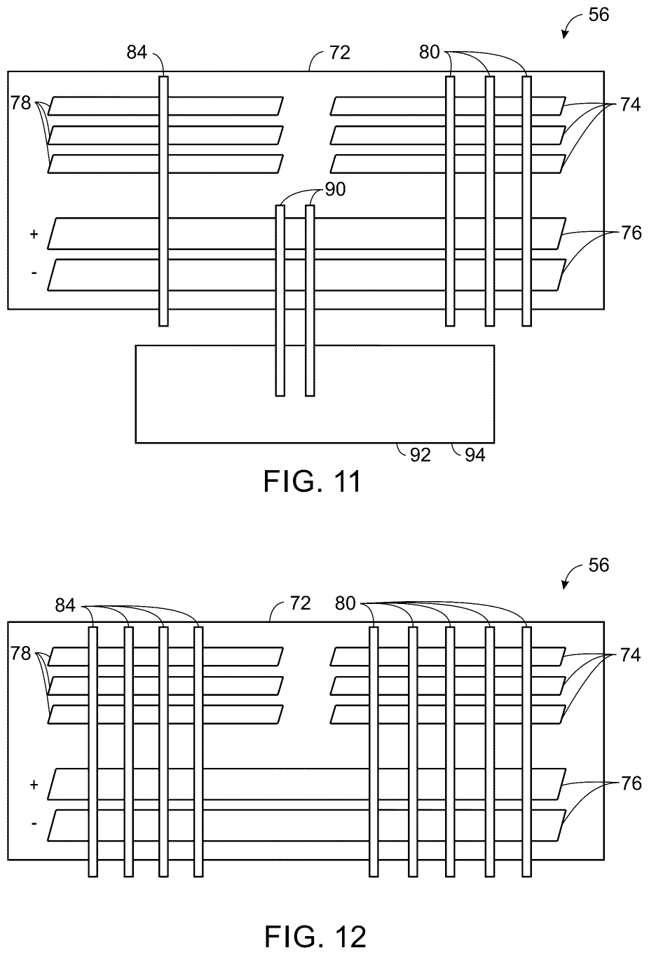

FIGS. 11 and 12 are schematic diagrams of different modular power distribution units 56 for the same CT imaging system but with different power requirements. For FIG. 11, the CT imaging system requires 210 kVA and 3 kVA for reconstruction. For FIG. 12, the same CT imaging system requires 210 kVA and 13 kVA for reconstruction. In FIGS. 11 and 12, the mains to DC boards 80 are each rated for 50 kVA, the peak-power shaving boards 90 are each rated for 50 kVA, and the DC to AC boards 84 are rated for 4 kVA. The modular power distribution unit 56 in FIG. 11 is similar to the power distribution unit 56 in FIG. 3. As depicted in FIG. 11, the modular power distribution unit 56 has three mains to DC boards 80 for a total rating of 210 kVA (from the power network to the machine), two peak-power shaving board 90 for an additional 100 kVA, and one DC to AC board 84 for an additional 4 kVA. In contrast, the modular power distribution unit 56 in FIG. 12 has more AC power. The modular power distribution unit in FIG. 12 lacks an energy storage system and instead has five mains to DC boards 80 for a total rating of 250 kVA (from the power network to the machine) and four DC to AC boards 84 for a total rating of 16 kVA.

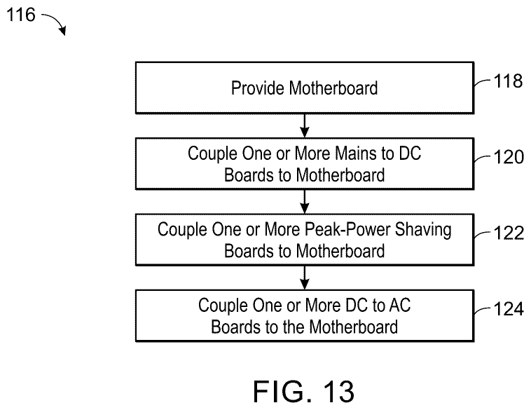

FIG. 13 is a flowchart of a method 116 for manufacturing a modular power distribution unit for an X-ray imaging device. One or more steps of the method 116 may be performed simultaneously and/or in a different order from that depicted in FIG. 13.

The method 116 includes providing a motherboard mechanically supporting a plurality of main bus bars, a plurality of DC bus bars, and a plurality of AC bus bars (block 118). The plurality of main bus bars is configured to receive electrical power from an electrical grid. The method 116 also includes coupling one or more mains to DC boards to the motherboard to electrically couple the plurality of mains bus bars to the plurality of DC bus bars (block 120). The one or more mains to DC boards are configured to absorb the electrical power from the plurality of mains bus bars, to convert the electrical power to DC power, and to provide the DC power to the plurality of DC bus bars. In certain embodiments, the method 116 further includes coupling one or more peak-power shaving boards to the motherboard to electrically couple an energy storage system to the plurality of DC bus bars (block 122). The one or more peak-power shaving boards are configured to access stored DC energy from the energy storage system and to provide the stored DC energy to the plurality of DC bus bars when a power demand exceeds a programmed threshold or to receive the electrical power to recharge the energy storage system. In certain embodiments, the method 116 includes coupling one or more DC to AC boards to electrically couple the plurality of DC bus bars to the plurality of AC bus bars (block 124). The one or more DC to AC boards are configured to absorb the DC power from the plurality of DC bus bars, to convert the DC power to AC power, and to provide the AC power to the plurality of AC bus bars.

Technical effects of the disclosed embodiments include providing a modular power distribution unit that provides a plug and play power distribution unit (e.g., common power distribution unit) for powering all types of X-ray systems. The modular power distribution unit is configured for all loads. The modular power distribution unit has a modular architecture built from four different types of boards. Technical effects of the disclosed embodiments include providing different types of boards (in particular, the mains to DC board and the mains to AC board) that are programmable to regulate voltages and frequencies. The programmability allows the same electrical hardware to fit any product hardware needs.

Technical effects of the disclosed embodiments include providing a modular power distribution unit can be easily and inexpensively scaled to product needs. The modular power distribution unit provides redundancies for maintenance and repair with no downtime. In particular, a single fault will not take down all of the power distribution unit. Technical effects of the disclosed embodiments include providing a modular power distribution unit that integrates peak-power shaving and energy storage. A power network upgrade may not be required with the availability of peak-power shaving. Technical effects of the disclosed embodiments include providing a modular power distribution unit includes a regulated (self-regulated) DC bus. This self-regulation avoids voltage droop issues. The modular power distribution unit also includes a built-in hot-landing feature.

Technical effects of the disclosed embodiments include enabling the design and manufacture of a limited number of boards for the modular power distribution unit that allows for scaling through different products as well as different modalities and options. Technical effects of the disclosed embodiments include providing fully programmable output voltages (both AC and DC), thus, providing the same hardware for different applications and/or power network connections. Technical effects of the disclosed embodiments include reducing cost due to mass production of a limited number of different boards. Technical effects of the disclosed embodiments include providing a modular power distribution unit that can be tailored to a customer's needs and/or to provide a solution for power availability. Technical effects of the disclosed embodiments include providing a more compact design.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A power distribution unit for an X-ray imaging device, comprising:
a motherboard mechanically supporting a plurality of mains bus bars, a plurality of direct current (DC) bus bars, and a plurality of alternating current (AC) bus bars, wherein the plurality of main bus bars is configured to receive electrical power from an electrical grid;
one or more mains to DC boards electrically coupling the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars; and
one or more peak-power shaving boards electrically coupling an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold; and
wherein the power distribution unit comprises a modular architecture.

2. The power distribution unit of claim 1, wherein the modular architecture of the power distribution unit is configured for use with different types of a same X-ray imaging modality and with different types of X-ray imaging modalities.

3. The power distribution unit of claim 1, wherein the one or more mains to DC boards are configured to regulate DC voltage of the DC power provided to the plurality of DC bus bars to a set DC voltage value.

4. The power distribution unit of claim 1, further comprising one or more DC to AC boards electrically coupling the plurality of DC bus bars to the plurality of AC bus bars, wherein the one or more DC to AC boards are configured to absorb the DC power from the plurality of DC bus bars, to convert the DC power to AC power, and to provide the AC power to the plurality of AC bus bars.

5. The power distribution unit of claim 4, wherein the one or more DC to AC boards are configured to regulate AC voltage of the AC power provided to the plurality of AC bus bars to both a set amplitude and a set frequency.

6. The power distribution unit of claim 4, wherein the one or more DC to AC boards are configured to provide single phase AC power to the plurality of AC bus bars.

7. The power distribution unit of claim 4, wherein the one or more DC to AC boards are configured to provide three-phase AC power to the plurality of AC bus bars.

8. The power distribution unit of claim 1, wherein the one or more peak-power shaving boards are configured to provide some of the DC power to the energy storage system for storage.

9. The power distribution unit of claim 1, wherein the one or more peak-power shaving boards comprise a plurality of peak-power shaving boards, and the energy storage system comprises a common energy storage element coupled to each peak-power shaving board of the plurality of peak-power shaving boards.

10. The power distribution unit of claim 1, wherein the one or more peak-power shaving boards comprise a plurality of the peak-power shaving boards, and the energy storage system comprises a plurality of energy storage elements, and each energy storage element of the plurality of energy storage elements is separately coupled to a respective peak-power shaving board of the plurality of peak-power shaving boards.

11. The power distribution unit of claim 1, further comprising one or more mains to AC boards electrically coupling the plurality of mains bus bars to the plurality of AC bus bars, wherein the one or more mains to DC boards are configured to absorb the electrical power from the plurality of mains bus bars and to provide AC power to the plurality of AC bus bars.

12. The power distribution unit of claim 11, further comprising one or more additional peak-power shaving boards electrically coupling an additional energy storage system to the plurality of AC bus bars, wherein the one or more additional peak-power shaving boards are configured to access stored DC energy from the additional energy storage system and to provide the stored DC energy to the plurality of AC bus bars when a power demand exceeds a programmed threshold.

13. The power distribution unit of claim 12, wherein the one or more additional peak-power shaving boards comprise a plurality of additional peak-power shaving boards, and the additional energy storage system comprises a common energy storage element coupled to each additional peak-power shaving board of the plurality of additional peak-power shaving boards.

14. The power distribution unit of claim 12, wherein the one or more additional peak-power shaving boards comprise a plurality of additional peak-power shaving boards, and the additional energy storage system comprises a plurality of energy storage elements, and each energy storage element of the plurality of energy storage elements is separately coupled to a respective additional peak-power shaving board of the plurality of additional peak-power shaving boards.

15. The power distribution unit of claim 1, wherein the plurality of DC bus bars is configured to couple to a DC uninterruptible power supply.

16. The power distribution unit of claim 1, wherein the plurality of AC bus bars is configured to couple to an AC uninterruptible power supply.

17. A medical imaging system, comprising:
an X-ray source configured to emit X-rays;
a high voltage generator configured to provide power to the X-ray source; and
a power distribution unit having a modular architecture and configured to receive electrical power from an electrical grid and to store the electrical power, wherein the power distribution unit is configured to regulate a high voltage direct current (DC) outputted to components of the medical imaging system including the high voltage generator, wherein the power distribution unit comprises:
a motherboard mechanically supporting a plurality of mains bus bars, a plurality of DC bus bars, and a plurality of alternating current (AC) bus bars, wherein the plurality of main bus bars is configured to receive the electrical power from the electrical grid;
one or more mains to DC boards electrically coupling the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars; and
one or more peak-power shaving boards electrically coupling an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold.

18. The medical imaging system of claim 17, further comprising one or more DC to AC boards electrically coupling the plurality of DC bus bars to the plurality of AC bus bars, wherein the one or more DC to AC boards are configured to absorb the DC power from the plurality of DC bus bars, to convert the DC power to AC power, and to provide the AC power to the plurality of AC bus bars.

19. A method for manufacturing a modular power distribution unit for an X-ray imaging device, comprising:
providing a motherboard mechanically supporting a plurality of main bus bars, a plurality of direct current (DC) bus bars, and a plurality of alternating current (AC) bus bars, wherein the plurality of main bus bars is configured to receive electrical power from an electrical grid;
coupling one or more mains to DC boards to the motherboard to electrically couple the plurality of mains bus bars to the plurality of DC bus bars, wherein the one or more mains to DC boards are configured to absorb the electrical power from the plurality of mains bus bars, to convert the electrical power to DC power, and to provide the DC power to the plurality of DC bus bars; and
coupling one or more peak-power shaving boards to the motherboard to electrically couple an energy storage system to the plurality of DC bus bars, wherein the one or more peak-power shaving boards are configured to access stored DC energy from the energy storage system and to provide the stored DC energy to the plurality of DC bus bars when a power demand exceeds a programmed threshold or to receive the electrical power to recharge the energy storage system.

20. The method of claim 19, further comprising coupling one or more DC to AC boards to the motherboard to electrically couple the plurality of DC bus bars to the plurality of AC bus bars, wherein the one or more DC to AC boards are configured to absorb the DC power from the plurality of DC bus bars, to convert the DC power to AC power, and to provide the AC power to the plurality of AC bus bars.
